(19) United States
(12) Patent Application Publication
(10) Pub. No.: US 2026/0227277 A1
(43) Pub. Date: Aug. 6, 2026

(54) PERFORMING DETECTION ON A TARGET DEVICE

(71) Applicant: Teradyne, Inc., North Reading, MA (US)

(72) Inventors: Haibo Liu, Winchester, MA (US); Iris Celebi, Somerville, MA (US)

(73) Assignee: Teradyne, Inc., North Reading, MA (US)

(21) Appl. No.: 19/466,740

(22) Filed: Feb. 2, 2026

Related U.S. Application Data
(60) Provisional application No. 63/753,523, filed on Feb. 4, 2025.

(51) Int. Cl. G01M 11/02; G01B 11/02; G01B 11/06; G01M 11/00

(52) U.S. Cl. CPC G01M 11/0207; G01M 11/31; G01B 11/026; G01B 11/0675

(57) ABSTRACT

An example test system includes a light source configured to output light; a photodetector to receive a reflection of the light; and an optical cable that is optically coupled to the light source and the photodetector. An end of the optical cable or a microlens at the end of the optical cable is configured to output the light from the light source to a target device to produce the reflection of the light.

### CROSS-REFERENCE TO RELATED APPLICATION

This application claims the benefit of, and priority to, U.S. Provisional Application No. 63/753,523, which was filed on Feb. 4, 2025 and titled “Performing Detection On A Target Device”. The contents of U.S. Provisional Application No. 63/753,523 are incorporated herein by reference.

### TECHNICAL FIELD

This specification describes example implementations of systems and processes for performing detections on a target device.

### BACKGROUND

A test system is configured to test the operation of a device. A device tested by a test system is referred to as a device under test (DUT). The test system may perform testing on optical components of the DUT, such as a waveguide. To perform such testing, a part of the test system moves within a proximity of the DUT and couples light from the test system to the optical components. Reflections of that light may be analyzed to determine whether the DUT passed or failed testing.

### SUMMARY

An example test system includes a light source configured to output light; a photodetector to receive a reflection of the light; and an optical cable that is optically coupled to the light source and the photodetector. An end of the optical cable or a microlens proximate to the end of the optical cable is configured to output the light from the light source to a target device to produce the reflection of the light. The example test system may include one or more of the following features, either alone or in combination.

The test system may include one or more processing devices to determine a distance to the target device based on the reflection received at the photodetector.

At least the optical cable and the microlens may be part of a test unit. The one or more processing devices may be configured to control movement of the test unit. The one or more processing devices may be configured to control movement of the test unit so as to prevent contact between at least part of the test unit and the target device. The one or more processing devices may be configured to determine, based on the reflection received at the photodetector, a thickness of one or more film layers on the target device.

The light source may be a first light source, the light may be first light, the photodetector may be a first photodetector, the optical cable may be a first optical cable, the microlens may be a first microlens, and the reflection may be a first reflection. The test system may include a second light source configured to output second light; a second photodetector to receive a second reflection of the second light; a second optical cable that is optically coupled to the second light source and the second photodetector; and a second end of the optical cable or a second microlens at the second end of the second optical cable to output the second light from the second light source to the target device to produce the second reflection.

The first microlens may be configured to output the first light to a first location on the target device and the second microlens may be configured to output the second light to a second location on the target device. The first location may be different from the second location.

The one or more processing devices may be configured to determine an alignment of the first microlens and the second microlens to the target device based on the first reflection and the second reflection. Each microlens may have a diameter of 5 microns to 200 microns.

The test system may include multiple optical test channels between the first optical cable and the second optical cable. The optical test channels may include respective optical cables having respective microlenses at ends thereof or no microlenses at ends thereof to perform optical testing at a surface of the target device. The surface may be either orthogonal to the optical test channels or at a non-zero angle relative to the optical test channels.

The microlens may be a first microlens and the reflection may be a first reflection. The optical cable may include an optical splitter to create a first optical line and a second optical line. The first microlens may be at an end of the first optical line and a second optical lens may be at an end of the second optical line. The first microlens may be configured to output a first part of the light to the target device and to receive the first reflection and the second microlens may be configured to output a second part of the light to the target device and to receive a second reflection of the second part of the light from the target device.

The test system may include multiple optical test channels. The optical test channels may include respective optical cables having respective microlenses at ends thereof or no microlenses at ends thereof to perform testing at a surface of the target device. The surface may be either orthogonal to the optical test channels or at a non-zero angle relative to the optical test channels. The first microlens and the second microlens may be configured to output, respectively, the first part of the light and the second part of the light. The first part of the light and the second part of the light may be output to a same location or to overlapping locations on the target device.

The microlens may be a first microlens. The test system may include a second microlens at the end of the optical cable. The first microlens may be configured to direct a first part of the light to a first part of the target device and the second microlens may be configured to direct a second part of the light to a second part of the target device. The first part of the target device may be different than the second part of the target device. The first part of the target device may be non-parallel to the second part of the target device. The first microlens may be designed not to have total internal reflection and the second microlens may be designed to have total internal reflection.

The at least the optical cable and the microlens of the example test system may be part of a test unit. The test system may include a fine positioning device configured to move the test unit relative to the target device in three dimensions; and a coarse positioning device configured to move the test unit and the fine positioning device relative to the target device in six degrees of freedom. The coarse positioning device may be configured to move over a range that is at least an order of magnitude greater than a range over which the fine positioning device is configured to move the test unit. The coarse positioning device may include one or more hexapods. The fine positioning device may include a piezoelectric positioner.

An example test system includes a light source configured to output light; a first optical cable that is optically coupled to the light source; a first end of the first optical cable or a first microlens proximate to the first end of the first optical cable may be configured to output the light from the light source to target device; a photodetector; a second optical cable that is optically coupled to the photodetector; and a first end of the second optical cable or a second microlens proximate to the second end of the second optical cable may be configured to receive a reflection of the light from the target device. The example test system may include one or more of following features either alone or in combination.

The first optical cable and the second optical cable may be part of a test unit. The test system may include a fine positioning device configured to move the test unit relative to the target device in three dimensions; and a coarse positioning device configured to move the test unit and the fine positioning device relative to the target device in six degrees of freedom. The coarse positioning device may be configured to move over a range that is at least an order of magnitude greater than a range over which the fine positioning device is configured to move the test unit.

The test system may include one or more processing devices to determine a distance to the target device based on the reflection received at the photodetector. The first optical cable and the second optical cable may be part of the test unit. The one or more processing devices may be configured to control movement of the test unit. The one or more processing devices may be configured to control movement of the test unit so as to prevent contact between at least part of the test unit and the target device. The one or more processing devices may be configured to determine, based on the reflection received at the photodetector, a thickness of one or more film layers on the target device.

The test system may include a substrate holding the optical cable. The substrate holds additional optical cables having respective microlenses at ends thereof or not to perform testing at a surface of the target device. The substrate may have a different dimension at the optical cable than at the additional optical cables. The substrate may be shorter at the optical cable than at the additional optical cables. The substrate may have a same dimension at the optical cable than at the additional optical cables.

An example method is for use with a test unit that includes at least first and second instances of an assembly containing one or more optical cables and one or more microlenses at one or more respective ends of the one or more optical cables. The method includes moving the test unit in a first dimension relative to a target device while a first assembly outputs first light to the target device and receives a first reflection of the first light and while a second assembly outputs second light to the target device and receives a second reflection of the second light; moving the test unit in a second dimension relative to the target device while the first assembly outputs third light to the target device and receives a third reflection of the third light and while the second assembly outputs fourth light to the target device and receives a fourth reflection of the fourth light, with the second dimension being different than the first dimension; and registering the test unit relative to the target device based on the first reflection, the second reflection, the third reflection, and the fourth reflection. The example method may include one or more of the following features, either alone or in combination.

The first dimension may be orthogonal to the second dimension. The target device may include grooves. Moving the test unit in the first dimension scans the first light across a first groove and scans the second light across a second groove. Moving the test unit in the second dimension scans the third light across the first groove and scans the fourth light across the second groove.

The test unit may include multiple optical test channels between the first assembly and the second assembly. The method may include, following registering, testing operation of the target device using the multiple optical test channels.

Any two or more of the features described in this specification, including in this summary section, may be combined to form implementations not specifically described in this specification.

At least part of the devices, systems, and processes described in this specification may be configured or controlled by executing, on one or more processing devices, instructions that are stored on one or more non-transitory machine-readable storage media. Examples of non-transitory machine-readable storage media include read-only memory, an optical disk drive, memory disk drive, and random access memory. At least part of the devices, systems, and processes described in this specification may be configured or controlled using a computing system comprised of one or more processing devices and memory storing instructions that are executable by the one or more processing devices to perform various control operations. The devices, systems, and processes described in this specification may be configured, for example, through design, construction, composition, arrangement, placement, programming, operation, activation, deactivation, and/or control.

The details of one or more implementations are set forth in the accompanying drawings and the following description. Other features and advantages will be apparent from the description and drawings, and from the claims.

### DESCRIPTION OF THE DRAWINGS

FIG. 1 is a block diagram of an example optical test system.

FIG. 2 includes a block diagram, front view of an example sensor channel that may be used in a fiber array unit (FAU) of the test system of FIG. 1.

FIG. 3 includes a block diagram, front view of an example sensor channel that may be used in the FAU of the test system of FIG. 1.

FIG. 4, comprised of FIGS. 4A and 4B, are block diagrams, front views of an example sensor channel that may be used in the FAU of the test system of FIG. 1, with the FAU being positioned at different points relative to a target device.

FIG. 5 includes a block diagram, front view of an example sensor channel that may be used in the FAU of the test system of FIG. 1.

FIG. 6 is a block diagram front view and top-down view of an example FAU configured to perform edge detection and alignment for a target device such as a DUT.

FIGS. 7A and 7B are block diagrams, front views of example sensor channels configured to determine the FAU fly height and thicknesses of one or more layers of a target device such as a DUT.

FIG. 8 includes a block diagram front view of an example sensor channel configured to identify two-dimensional (2D) patterns on a surface of a target device such as a DUT, where the target device is also shown in a top-down view.

FIG. 9 includes a block diagram, front view of an example sensor channel that may be used in the FAU of the test system of FIG. 1.

FIG. 10 includes a block diagram, front view of an example sensor channel that may be used in the FAU of the test system of FIG. 1.

FIGS. 11A and 11B are block diagrams, front views of example sensor channels that may be used in the FAU of the test system of FIG. 1.

Like reference numerals in different figures indicate like elements.

### DETAILED DESCRIPTION

Described herein are examples of systems and processes for testing optical devices or DUTs, such as silicon photonic wafers containing optical waveguides, photonic integrated circuits (PICs), optical modulators, photodetectors, fiber optic transceivers, photonic sensors, or the like. An example PIC may include a microchip containing two or more photonic components. The systems and processes described herein may be configured to test any component designed to generate, manipulate, or detect light within a photonic system. The systems and processes described herein may be used with any type of target device, including devices that are not under test. However, the examples described herein are in the context of testing.

Testing optical devices may be performed to ensure their performance, reliability, and compatibility in optical systems. Examples of tests performed on optical devices evaluate parameters such as insertion loss, return loss, polarization-dependent loss (PDL), and wavelength response, among others. Test equipment, such as optical spectrum analyzers, optical power meters, and tunable lasers, may be used to assess these properties. Functional tests may include measuring the modulation efficiency of optical modulators or the sensitivity of photodetectors.

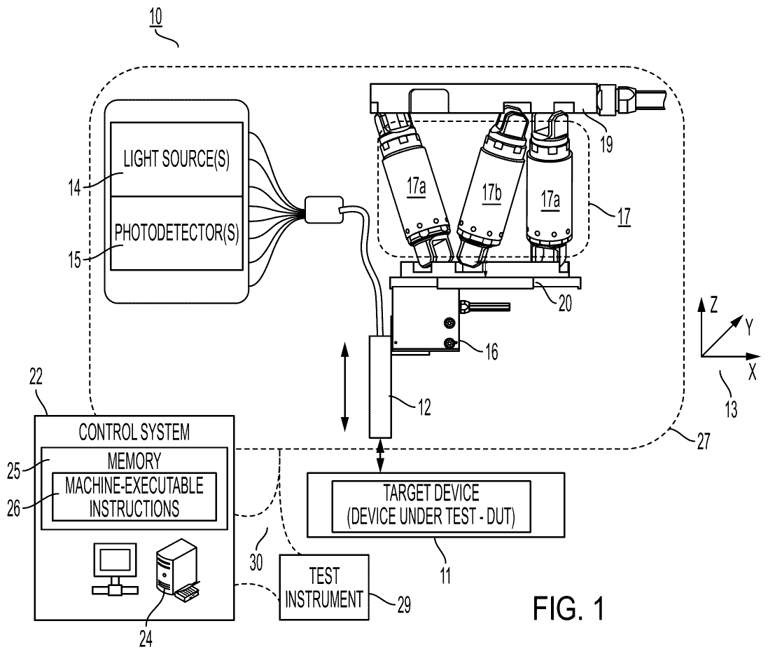

FIG. 1 shows components included in an example test system 10 for testing an example device (referred to herein simply as the DUT or DUT 11). Test system 10 includes an example fiber array unit (FAU) 12. FAU 12 is a test unit or component configured to align and to hold multiple optical cables, each comprised of one or more optical fibers, in a fixed geometric configuration. Each optical cable may include one or more optical fibers such as single mode fibers (SMF), polarization maintaining fibers, or multimode fibers. In some implementations, SMF fibers may be used to implement optical channels, which are configured to emit Gaussian or near-Gaussian light beams.

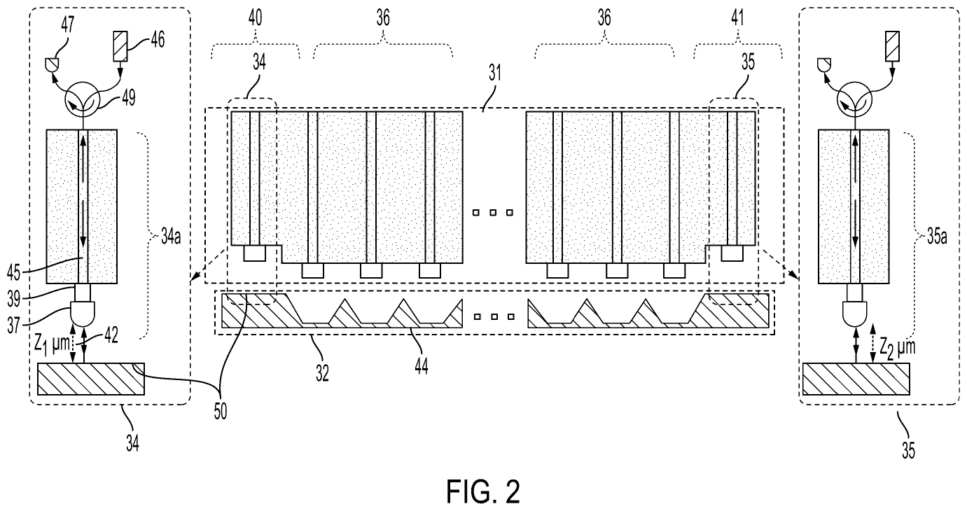

FAU 12 may include a base material or substrate, such as glass or ceramic, that contains etched or drilled grooves to position the optical cables with, e.g., single-digit, double-digit micron (μm), or sub-micron accuracy. In some implementations, the optical cables may be secured in these grooves and may be bonded using adhesives or mechanical clamps. In some implementations, the optical cables may be secured within the grooves yet configured to move within grooves to allow movement of the optical cables towards or away from the DUT while the rest of the FAU remains stationary relative to the DUT. Example implementations of example FAU 12 are described with respect to FIGS. 2 to 11 below.

Example FAU 12 is configured to enable alignment to DUT 11 accurately to implement effective testing or measurements. By employing hardware and software integration, FAU 12 can, in some implementations, achieve sub-micron distance sensing and alignment to guide photonic device tests and/or measurements.

FAU 12 is optically coupled to one or more light sources 14 and to one or more photodetectors 15 (also referred to as one or more optical detectors), an example of which is an optical power meter. In some implementations, the light source(s) and photodetector(s) are part of FAU 12. The light source(s) may be lasers, light-emitting diodes (LEDS), or other light radiation components from ultraviolet to infrared. In the following descriptions, laser light is used as an example.

The implementations described herein use lasers as example light sources 14. Laser(s) 14 are configured to output laser light to DUT via the FAU. Reflections of the laser light from the DUT may be measured by the photodetector(s) 15 during testing.

An example photodetector 15 includes a sensor configured to convert light into an electrical signal. Example types of photodetectors include photodiodes, phototransistors, and charge-coupled devices (CCDs), each configured for different applications depending on factors like sensitivity, speed, and wavelength range.

An example optical power meter is a photodetector configured to measure the power of an optical signal. The optical power meter may be or include photodetection circuitry or other components that convert incoming light into an electrical signal. Example optical power meters may be configured to measure both continuous wave (CW) and modulated signals, providing readings in units such as milliwatts (mW) or decibels relative to a reference level (dBm). Outputs from optical power meters may also be used for determining optical signal strength.

Test system 10 is configured to move FAU 12 relative to DUT 11 before, during, and after testing. To this end, test system 10 may include a fine positioning device configured to move the FAU relative to the DUT in three dimensions and a coarse positioning device configured to both move the FAU and the fine positioning device relative to the DUT in six degrees of freedom. In some implementations, the coarse positioning device is configured to move over a range that is at least an order of magnitude greater than a range over which the fine positioning device is configured to move the FAU. In some implementations, the fine positioning functionality and coarse positioning functionality may be integrated into a single device or system.

In some implementations, the fine positioning device is, or includes, a piezoelectric positioner 16 configured to move the FAU at, e.g., micron or sub-micron precision up to 100 microns or more. An example piezoelectric positioner is a high-precision motion device configured to control movement in three dimensions, e.g. along three axes (e.g., Cartesian X, Y, and Z axes 13) using the piezoelectric effect. More specifically, when an electric voltage is applied to piezoelectric elements in the piezoelectric positioner, the piezoelectric elements expand or contract, enabling relatively accurate positioning at, e.g., in the micron or nanometer (e.g., less than 10 nanometer) scale. Piezoelectric positioner 16 may provide rapid response, high resolution, and smooth motion with reduced mechanical backlash. The FAU may be physically coupled to the piezoelectric positioner 16 as shown; accordingly, movement of the piezoelectric positioner causes movement of the FAU.

In some implementations, the coarse positioning device is, or includes, one or multiple (e.g., three) hexapods 17 configured to control movement of the fine positioning device and the FAU in six degrees of freedom relative to the DUT. The six degrees of freedom may include the six independent ways a rigid body can move in three-dimensional space, including three translational movements (forward/backward, up/down, left/right relative to the DUT) along three perpendicular axes and three rotational movements (yaw, pitch, roll) around those axes. These movements may constitute the full range of motion that the fine positioning device and the FAU can experience in three-dimensional (3D) space.

Example hexapod 17 is a robotic component or mechanical device that is configured to move the piezoelectric positioner and the FAU, e.g., across the entire diameter or length and width of a silicon wafer, e.g., 100 millimeters (mm), 125 mm, 150 mm, 200 mm, 300 mm, or more. Example hexapod 17 may be or include a leg, each with, none, one, or more joints for allowing a range of motion. In the example of FIG. 1, each hexapod 17a, 17b, 17c is physically coupled to rigid body 19 to move relative to, and along, rigid body 19. Hexapods 17 are physically coupled to piezoelectric positioner 16 via one or more structures 20 such one or more rails or plates such that movement of the hexapods is transferred to, and causes corresponding movement of, the piezoelectric positioner 16 and the FAU coupled thereto.

Test system 10 also includes a control system 22. Control system 22 may include one or more processing devices 24 and memory 25 storing instructions 26 that are executable. The one or more processing devices 24 may execute instructions 26 to control and/or to receive information from components 27, including the laser(s) and photodetector(s), the hexapods, the piezoelectric positioner, and the FAU to implement the testing systems and processes and variants thereof described herein. In some implementations, all or part of the control functionality attributed to control system 10 may also or instead be implemented on a test instrument 29 that is part of test system 10. In some implementations, at least part of the control functionality may be distributed across processing device(s) 24 and/or one or more test instruments 29.

A test instrument, such as test instrument 29, is a hardware device, which may include one or more processing devices and programmable logic, such as an FPGA (field programmable gate array), and memory. The test instrument may execute test programs to test DUTs. Communications among components 27, control system 22, and test instrument 29 may be wired or wireless and are depicted by dotted lines 30.

FIG. 2 is a close-up and cross-sectional front view of an example implementation of FAU 12 (labeled FAU 31) and an example DUT 32. This implementation shows FAU 31 containing eight optical cables, each forming or being part of an optical channel; however, an FAU may include more than, or fewer than, eight optical cables, e.g., tens (e.g., 22 to 36), hundreds, or thousands of optical cables. Thus, FAU 31, which may have a width of about 0.1 millimeters (mm) to 10 mm in some implementations, may have multiple such optical channels. Two or more optical channels on the FAU, e.g. the two optical channels 34, 35 at opposite ends of FAU 31, may be configured to operate as sensor channels to perform three-dimensional (3D) sensing of structures on the DUT, a distance to the DUT, and/or alignment of the FAU relative to DUT 32, among other things. The remaining optical channels 36 of the FAU-for example, multiple optical channels 36 between sensor channels 34, 35 or located elsewhere on the FAU-may be configured and controlled to perform optical testing on the DUT. Examples of such optical tests include, but are not limited to, those described above. These optical channels used for testing may have either direct fiber outputs or laser light output with desirable working distances to the DUT. The direction of light emission direction may be either downwards (for vertical coupling) or sidewards (for edge coupling). For example, the surface of the DUT during testing may be either orthogonal to the optical test channels or at a non-zero angle relative to the optical test channels.

In some implementations of the FAU, every optical cable, multiple but not all optical cables, or none of the optical cables may include a microlens 37 at the end of an optical cable 45. An example microlens is a small optical lens, which may have a diameter ranging from tens to hundreds of (e.g., 50) microns, that is configured to focus or to manipulate light at a microscopic scale. In some implementations, an optical waveguide 39 may connect each microlens to its corresponding optical cable. Accordingly, the microlens may be proximate to the end of the optical cable rather than directly connected to the end of the optical cable. In some implementations, an optical waveguide may be omitted and each microlens may connect directly to a respective optical cable.

Microlenses that may be used herein can be made from materials such as optical glass or polymers, and may be spherical in shape, aspherical in shape, or cylindrical in shape, for example. In some implementations, each microlens on each corresponding optical cable has the same shape and dimensions. In some implementations, different microlenses on different optical cables have different shapes and dimensions. In some implementations, each microlens has a diameter of 5 microns to 200 microns; however, other implementations may have different dimensions. In some implementations, each microlens is 3D-printed onto the end of its corresponding optical cable or waveguide. In some implementations, each microlens may be or include a meta material lens or may be fabricated using other known techniques and attached to the end of its corresponding optical cable or waveguide. In some implementations, combinations of 3D-printed and other types of microlenses may be used in the same FAU.

The microlens can have a focal length to direct the light onto a target surface with a desirable beam size/diameter. The distance sensing range and lateral scanning resolution of the FAU as described below may be based on these parameters.

At different locations, such as at opposite ends, 40, 41 of FAU 31, FAU 31 includes an assembly that functions as a sensor channel. In this example, the sensor channels 34, 35 are enlarged to show the details thereof. In this example, assemblies 34a and 35a are identical; accordingly, only assembly 34a is described. In other implementations, including examples described below, different assemblies implementing sensor channels on the same FAU may have different configurations. In the example of FIG. 2, two sensor channels 34, 35 are each slightly shorter than the testing channels 36 due to specific DUT structures. That is, in FIG. 2 the DUT has V-shaped grooves. The testing channels may be shifted down into the grooves for testing. So, sensor channels 34, 35 are slightly shorter than channels 36 to avoid hitting the DUT surface at the two opposite ends of V-shaped grooves. For some other DUT structures such as trenches with enough length where two opposite ends of the FAU will not hit the DUT surface, sensor channels 34, 35 may have the same length as other optical channels because two sensor channels can be shifted into trenches as well. The length of the sensor channels may depend on the specific DUT structure. This applies to any configurations that are described subsequently.

The sensor channels 34, 35 may be configured to determine the distance (e.g., the vertical (Z) 42 (or other distance) between the optical cable(s) (or the FAU) and the DUT. In FIG. 2, DUT 32 includes an array of V-shaped (or other shaped) grooves 44 leading to waveguides to be tested on DUT 32. During testing, laser light from the test channels is coupled into waveguides through the edges of the V-shaped grooves. Other DUTs may have trenches instead of V-shaped grooves leading to waveguides. The sensor channels 34, 35 may be used to determine the distance between optical cable(s) (or the FAU) and the DUT with respect to flat or substantially flat (e.g., less than 5% deviation from completely flat) surfaces of the DUT or from all or part of the V-shaped or other shaped grooves or trenches on the DUT.

Assembly 34a includes an optical cable 45 that is optically coupled to a laser source 46 and to a photodetector 47, which may be part of the laser(s) and photodetector(s) described with respect to FIG. 1, and a microlens 37 at an end of the assembly. In some implementations, the microlens may be omitted from the assembly. Connection between the optical cable 45 and both photodetector 47 and laser 46 may be implemented using an optical circulator 49. An example optical circulator includes a non-reciprocal optical device that directs light in a particular direction while preventing it from flowing backward. An optical circulator may include three or more ports, where light enters at one port and is directed sequentially through the others in a fixed order. For example light entering a port 1 (laser light from the laser source) will be directed to a port 2 (to the optical cable and microlens if present), and light entering port 2 (from the optical cable and microlens if present) will be directed to a port 3 (to the photodetector), for example, without allowing any reverse flow from port 2 to port 1 (to the laser source).

In operation, laser 46 is controlled by the control system to output laser light, which passes through optical circulator 49 and optical cable 45 to microlens 34. The laser light reflects from the surface 50 of DUT 32 and the resulting reflected light, which may also be referred to simply as a reflection, passes back through microlens 37, waveguide 39, optical cable 45, optical circulator 49, and to photodetector 47. The photodetector captures the reflected light.

In some implementations, before distance sensing in the Z dimension (referred to as Z distance sensing) is performed, the whole FAU may be aligned in parallel to the surface 50 of the DUT so that light can be emitted perpendicularly on the DUT surface and reflected back to the sensor channels. This can be achieved by performing angular scanning along pitch, roll and yaw axes to obtain the maximum reflection from the DUT surface from a high fly height or Z distance, for example, of a few hundred microns.

The laser light output by each sensor channel may include Gaussian or near-Gaussian laser beams, which have certain Raleigh ranges and divergence angles, so that light power of the reflected laser beams collected by the optical cable and photodetector may be correlated to the vertical 42 (or Z) distance from a surface 50 of the DUT. In some implementations, the control system obtains measured light power from the photodetector and uses that information to determine the Z distance. The system may be calibrated beforehand using an accurate distance measurement method, such as using optical confocal sensor or capacitive sensor. In some implementations, Z distance sensing may be accurate to distances as low as two (2) microns (μm) or less to five (5) microns or more depending on the system configuration. Microlens 37 may be designed to have a focal distance that allows the optimal Z distance sensitivity and lateral scanning resolution as described herein. After two Z distances are determined by the two sensors, the FAU's Z position can be translated or rotated to align with the DUT for additional measurements.

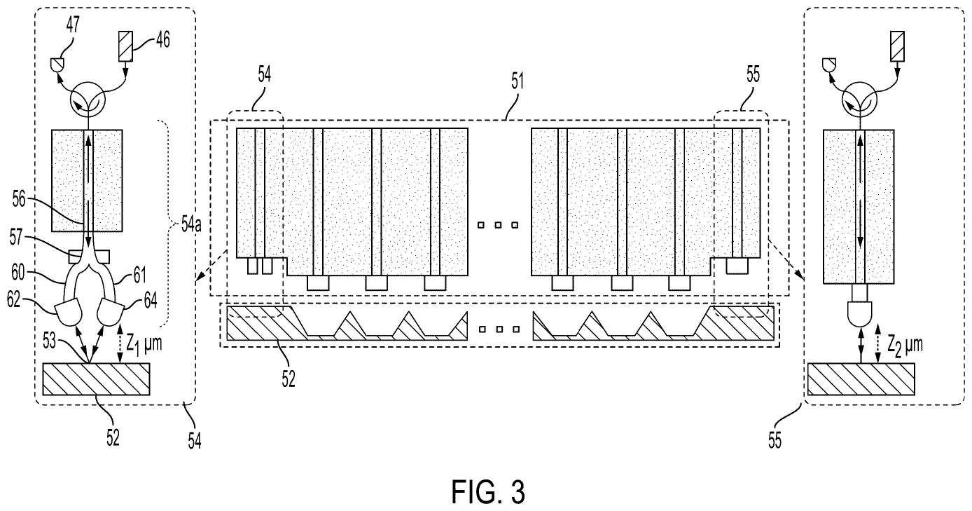

FIG. 3 is a close-up and cross-sectional front view of another example implementation of FAU 12 (labeled FAU 51) and an example DUT 52. In this example, the sensor channels 54, 55 are enlarged to show the details thereof. Except for the difference in configuration of the sensor channel(s), FAU 51 may be identical in structure and function to FAU 31. Accordingly, only the differences with respect to the sensor channel(s) are addressed with respect to FIG. 3.

In some implementations, the configuration of FIG. 3 is similar to the configuration of FIG. 2 with the first channel and last channel being used as optical sensors for distance sensing and alignment. But in the configuration of FIG. 3, one or both sensor channels may have different microlenses from the configuration of FIG. 2. In channel 54, the laser beam is split into two angled sub-channels for fly height or Z distance sensing, which may achieve improved accuracy (potentially 5 to 10 times better) than the single channel sensor as the configuration of FIG. 2. The distance sensing range of the configuration of FIG. 3 may be smaller than that of the configuration of FIG. 2. However, once that small range of distance sensing is accurately measured and registered with the positioners, the control system can control the FAU and translate and rotate the FAU in a larger range to align with the DUT.

In the example of FIG. 3 one or both of the sensor channels 54, 55 may have the configuration of assembly 54a. The other sensor channel 55 may have the same configuration as assembly 54a or the configuration of assembly 34a of FIG. 1 or any of the other sensor channel configurations described herein. Assembly 54a includes an optical cable 56 that has, along its length, an optical splitter 57 to create a first optical line 60 and a second optical line 61. The first optical line 60 and the second optical line 61 may each include one or more optical fibers and/or waveguides.

In this example, the first optical line 60 and the second optical line 61 are at a non-zero angle relative to the optical cable 56 and their outputs are angled towards each other so that laser light from each optical line hits the same surface 53 of the DUT or overlaps at least partly on the DUT. For example, each optical line may be angled between 10° and 45° relative to optical cable 56 and towards the other optical line.

An example optical splitter is a device configured to divide an incoming optical signal into multiple output signals. The optical splitter enables the distribution of laser light from a laser 46 to the first optical line 60 and the second optical line 61. Optical splitter 57 has a 1×2 configuration in which there is one input port and two output ports. In some implementations, there may be more than two optical lines, which may be implemented using splitters in 1×3, 1×4, and so forth configurations.

In some implementations, each optical line 60, 61 has a microlens 62, 64 at an end thereof, examples of which are described herein; although some implementations do not include microlenses either in one or more testing channels or one or more sensor channels. In some implementations, microlenses 62, 64 may be configured to have a focal distance that allows the optimal Z distance sensitivity and lateral scanning resolution as described herein. In implementations where microlenses are used, first microlens 62 is configured to output (e.g., to pass) a first part of the laser light from laser 46 to DUT 52 and to receive a first reflection of the first part of the laser light from DUT 52 and second microlens 64 is configured to output a second part of the laser light from laser 46 to DUT 52 and to receive a second reflection of the second part of the laser light from DUT 52. In implementations where microlenses are not used, first optical line 60 is configured to output a first part of the laser light to DUT 52 and to receive the first reflection from the DUT and second optical line is configured to output the second part of the laser light to DUT 52 and to receive the second reflection from DUT 52. In both implementations, the control system may determine distances between the distance between the optical cable(s) (or the FAU) and the DUT based on information from photodetector 47 about these reflections in the manner described herein.

In some implementations, the distance determined by an assembly having the configuration of assembly 54a (e.g., two optical lines 60, 61 or more) may be five to ten times more accurate than the distance determined by an assembly having the configuration of assembly 34a (e.g., one optical path, FIG. 1). Such high accuracy may result from the light detected being sensitive to the exact Z distance as a result of triangulation and Gaussian beam coupling, potentially with sub-micron sensitivity. After the distance between the optical cable(s) (or the FAU) and the DUT is determined and the control system registers that distance with the piezoelectric positioner and hexapods, the control system can control the FAU translationally and/or rotationally, to align the FAU with the DUT.

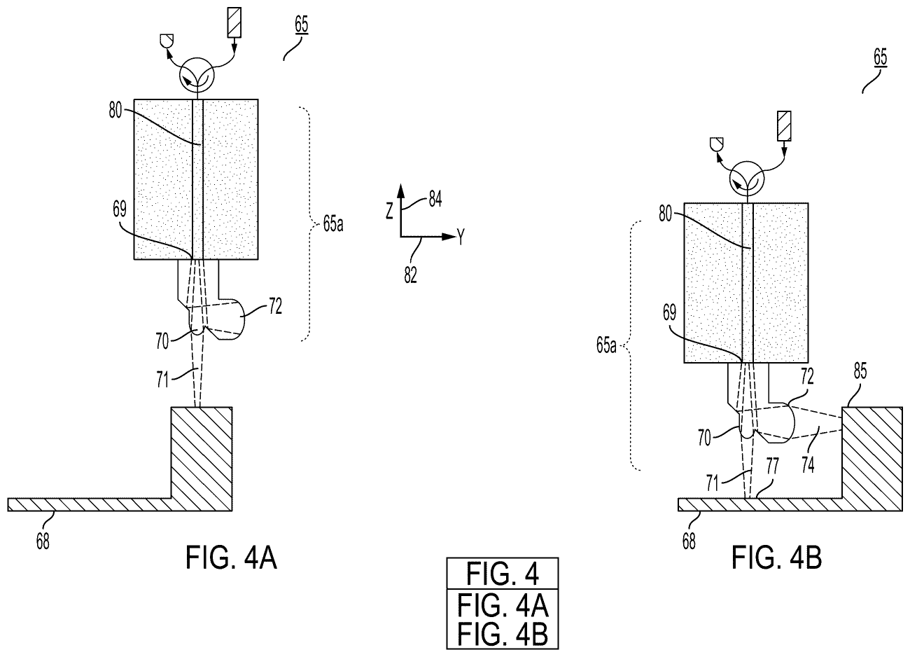

FIGS. 4A and 4B are close-up and cross-sectional front views of another example implementation of part of FAU 12. In this example, only sensor channel 65 of the FAU is shown. The remainder of the FAU, which is not shown in FIGS. 4A and 4B, may include test channels and another sensor channel like those shown and described herein. For example, sensor channel 65 may be incorporated into an FAU like those of FIG. 2, 3, 5, 6, 8, 9, or 10.

FIG. 4A shows the FAU at one location relative to DUT 68 and FIG. 4B shows the FAU at a different location than that shown in FIG. 4A relative to the DUT.

In this example, assembly 65a includes a light output section with two microlenses at the end 69 of its optical cable 80 or waveguide. The first microlens 70 is configured to direct a first part 71 of the laser light to a first part of a DUT 68 and a second microlens 72 is configured to direct a second part 74 of the laser light to a second part of the DUT. The first part of the DUT may be different than the second part of the DUT, as shown. As shown in FIG. 4B, the first part 77 of the DUT may be non-parallel to the second part 79 of the DUT such that laser light 72 directed to the surface of the DUT is parallel to the FAU's fiber axis and laser light 74 is directed to angled surfaces of the grooves or trenches of the DUT described previously. The first microlens 70 may be designed not to have total internal reflection and the second microlens 72 may be designed to have total internal reflection.

In this regard, the first and second microlenses may be part of a single lens structure, which may be 3D-printed onto the end 69 of optical cable 80 or a waveguide or applied via other techniques described herein. The microlenses split the laser light output into two beams: one emitted at a 0° or substantially 0° angle (e.g. less than 5% from 0°) relative to the axis of optical cable 80 and one at a non-zero angle relative to the axis of the optical cable 80, such as a 30°, 45°, 90°, or any other angle. The single lens structure may have an inner center portion forming the first microlens and a second microlens that surrounds the inner lens and has an outer circular or donut shape.

This single lens structure may be implemented by 3D printing a smaller Lens_1 70 at the inner center portion (or one-half portion) that has internal total reflection and that outputs the laser light at 0° (referred to as vertical). This single lens structure may be implemented by 3D printing an outer Lens_2 72 around the smaller Lens_1 having an outer circular or donut portion (or another half portion), having internal total reflection and that deflects the laser light at an angle (referred to as sideway), such as those described above. The vertical laser light (e.g., 71) may be used for vertical or Z distance 84 sensing while the sideways laser light (e.g., 74) may be used for non-vertical or Y distance sensing. The non-vertical or Y 82 distance sensing, which may be performed using the sideways laser light, may be used to obtain spacing data to perform optical edge coupling into a waveguide and to prevent the FAU from contacting the DUT during testing (referred to as crash prevention, described below).

When the FAU is moved along Z axis 84 as described herein, the vertically reflected light power from the DUT's is constant. When the FAU is moved along Y axis 82, the vertically reflected light power from the DUT's surface is constant for flat surfaces like surface 77, but changes when the light passes over a groove or trench edge in the DUT, such as edge 85. This difference in optical power enables the control system to determine when an edge on the DUT has been encountered. The control system may determine a shape of the edge based on changes in magnitudes of the optical power. That is, different heights of an edge correlate to different optical powers. Changes in optical powers, therefore, may be used to determine shapes of the edges.

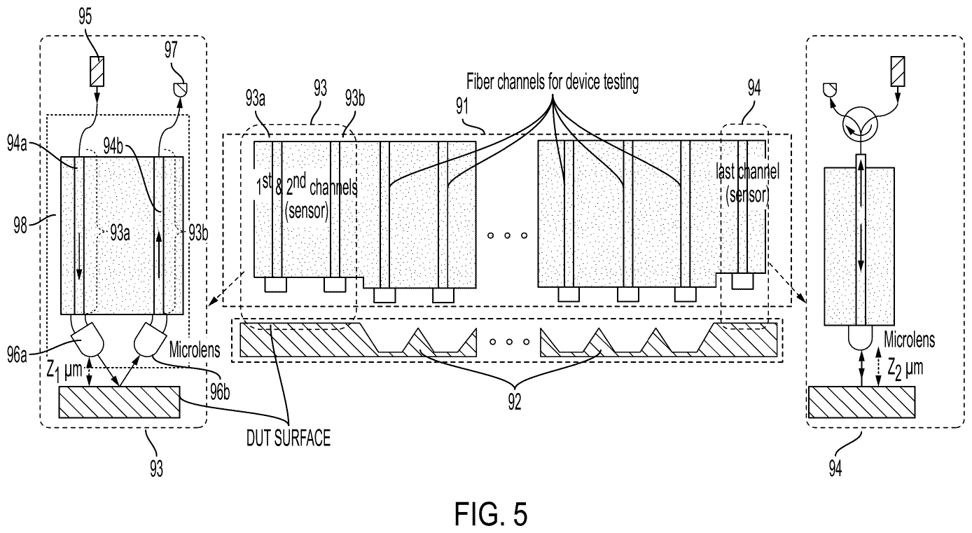

FIG. 5 is a close-up and cross-sectional front view of another example of FAU 12 (labeled FAU 91) and an example DUT 92. In this example, the sensor channels 93, 94 are enlarged to show the details thereof. Except for the difference in configuration of one or both of the sensor channel(s), FAU 91 may be identical in structure and function to FAU 31. Accordingly, only the differences with respect to the sensor channel(s) are addressed with respect to FIG. 5.

Example FAU 91 implements sensing using pairs of FAU channels-for example two channels 93a, 93b at one end or other location of an FAU may form a first sensor channel. In some examples, two channels at another end or other location of the FAU having the same configuration as channels 93a, 93b may form a second sensor channel, although the implementation of FIG. 5 shows a sensor channel like that of FIG. 2 as sensor channel 94. Only sensor channel 93 is described, since other sensor channels in the FAU may have the same structure and function.

In this example, sensor channel 93 includes first channel 93a and second channel 93b. First channel 93a includes a first optical cable 94a that is optically coupled to a light source (in this example, a laser) 95. An end of the first optical cable or a first microlens 96a at the end of the first optical cable is configured to output the laser light from the laser source to the surface of the DUT. Second channel 93b includes a second optical cable 94b that is optically coupled to a photodetector 97. An end of the second optical cable or a second microlens 96b at the end of the second optical cable is configured to receive a reflection of the laser light reflected from the surface of the DUT. The components may have the same structure and function as counterpart components of other implementations described herein. In some implementations, the laser and photodetector are optically coupled to, and not part of the optical channels. In some implementations, the laser source and photodetector are considered to be a part of the optical channels.

In this example, the output of channel 93a and the input of channel 93b are angled towards each other. For example, the output of channel 93a and the input of channel 93b may be angled between 10° and 45° relative to respective optical cables 94a, 94b. In operation, laser light is output to the DUT over first optical channel 93a. Reflections from that laser light are received through the second optical channel 93b. The photodetector 47 detects information about the reflections that is provided to the control system and used by the control system to determine their power and time of receipt. The control system may determine the distance between the FAU and the DUT based on this information as described previously.

In some implementations, channels 93a, 93b form an optimal emitting and receiving geometry when the FAU's fly height (e.g., height relative to the DUT) is equal to or within a predefined tolerance of a designed height Z1. This configuration may achieve better accuracy (potentially 5 to 10 times better) than the single channel sensor of FIG. 2. This is because the fly height close to Z1 achieves an improved coupling between two sensor channels. A small fly height deviation (e.g., 0.5 micron or less) from Z1 may cause an apparent power difference of the optical signal coupled into channel 93b. Upon collecting detected laser light power with the photodetector while scanning along the Z axis around Z1, the fly height of Z1 can be identified and passed to the control system to register the fly height accurately. The height can be calibrated by another accurate distance measurement method. The distance sensing range of the FIG. 5 implementation may be smaller than that of the FIG. 2 implementation. However, once that small range of distance sensing is accurately measured and registered with the piezoelectric hexapods and positioners, in some implementations the FAU can be translated and rotated in a larger range to align with the target device.

The angled outputs and inputs in the configuration of FIG. 5 may reduce or eliminate interference patterns in a detected signal. The single channel sensor as shown in the configuration of FIG. 2 uses the same optical channel to emit and to receive light reflected from different interfaces, for example, the interfaces of fiber/lens (or waveguide), lens/air, and air/target surface. Such reflections are received by the photodetector. These light reflections may interfere and form undesired patterns in a detected signal (in either the Z distance domain or wavelength domain). Such patterns in the detected signal may, in some cases, impact the distance sensing accuracy. By contrast, in the configuration of FIG. 5, reflected light from different interfaces may not be received and, as a result, the detected reflection is wholly or mainly from the light reflected from the air/target surface of the DUT. As a result, the foregoing interference patterns can be reduced or eliminated. In this case, distance sensing accuracy may be improved. In addition, microlenses 96a, 96b may have a designed focal length to direct the light onto the target DUT surface with a desirable beam size/diameter, which may affect the distance sensing range and lateral scanning resolution as described herein. Microlenses 96a, 96b may be designed to have a focal distance that achieves improved Z distance sensitivity and lateral scanning resolution.

The configuration of FIG. 5 can be used in a range of applications. The two angled channel sensor 93 may be used for fine distance sensing as Z1, with a relatively high accuracy, e.g. +/−0.5 μm, and a small distance sensing range, e.g., 10 μm. The single channel sensor 94 may be used for coarse distance sensing as Z2, with a relatively low accuracy, e.g. +/−5 μm, and a large distance sensing range, e.g., 200 μm.

Due to its potential sub-micron accuracy, the two-angled channel sensor 93 of FIG. 5 may be used to detect small mechanical vibrations of the FAU, e.g., from sub-micron vibrations to a few micron vibrations. Such small mechanical vibrations of the FAU from a test tool or the FAU surroundings can be challenging to avoid in the process of testing the DUT and may cause undesirable noise in the test results. The vibrational signals can be detected by this sensor and signals may be used to compensate for these vibrations, achieving test results with reduced or no noise.

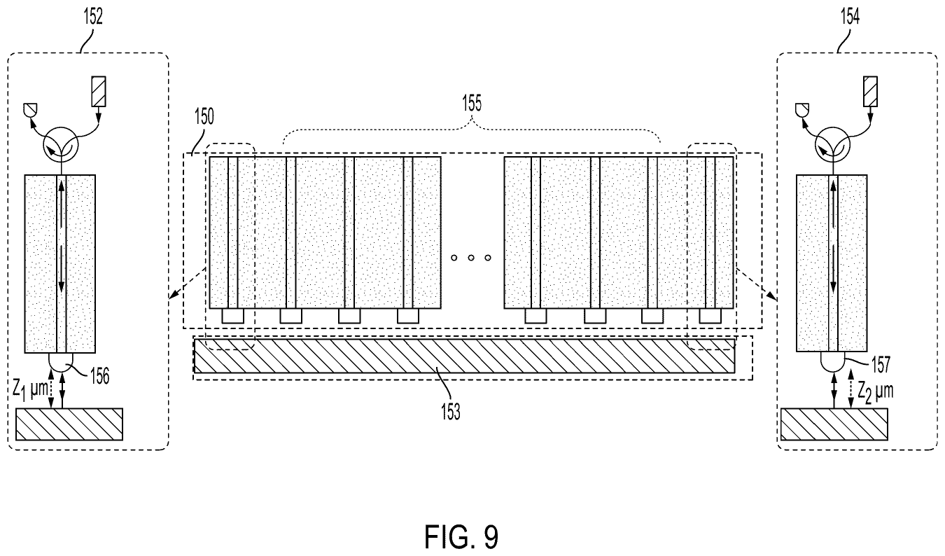

FIG. 9 is a close-up and cross-sectional front view of an example implementation of FAU 12 (labeled FAU 150) and an example DUT 153. This implementation of the FAU is identical to example FAU 31 of FIG. 2, except that (i) sensor channels 152, 154 are not shorter than test channels 155, e.g., sensor channels 152, 154 may be the same length as the test channels, and (ii) microlenses 156, 157 of the sensor channels can be different from those in FIG. 2 to fit for DUT configurations. This implementation of the FAU may be useful with DUTs, such as DUT 153 that does not include grooves or trenches or that includes grooves or trenches that are small relative to the microlenses. The operation of FAU 150 may be the same as FAU 31 of FIG. 2, except for differences in operation resulting from different configurations. For example, FAU 31 of FIG. 2 may be more suited to edge detection than FAU 150. Any sensor channel configuration described herein, modified to have a same channel length as the test channels, may be substituted for the configuration of sensor channels 152, 154 that is shown in FIG. 9.

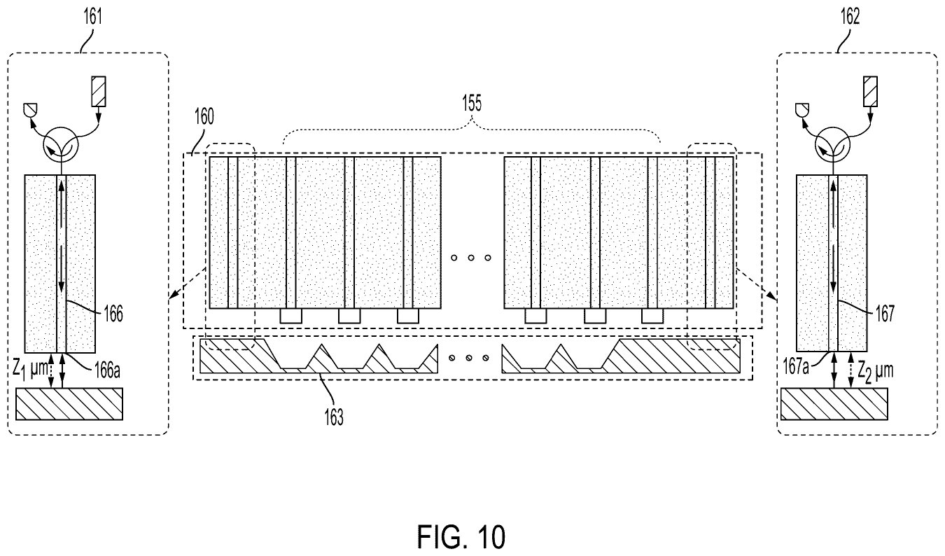

FIG. 10 is a close-up and cross-sectional front view of an example implementation of FAU 12 (labeled FAU 160) and an example DUT 161. This implementation of the FAU is identical to example FAU 150 of FIG. 9 and except that the sensor channels 161, 162 do not include microlenses. Rather, light exits the optical waveguide or fiber optic cables 166, 167 of the respective sensor channels 161, 162 directly and reflects directly back into the fiber optical cable from the DUT 163. Without the focusing provided by the microlenses, light from the fiber optic cable may disperse over the DUT. As such, in some implementations of the FAU that do not include microlenses at the input/output the sensor channels like that of FIG. 10, the ends 166a, 167a of the fiber optic channels may be within 300 micros (μm) or less of the surface of the DUT to make measurements of the type described herein. In some implementations, including microlenses at the input/output the sensor channels like that of FIG. 9 enables the microlenses to be greater than 300 μm from the surface of the DUT to make measurements of the type described herein. Generally, including a focusing microlens on the sensor channel enables making measurements at greater distances from the DUT than not including such a microlens. In this example, DUT 163 includes grooves or trenches like DUT 32 of FIG. 2; however, DUT 163 may have a flat or substantially flat surface like that of DUT 153. The operation of FAU 160 may be the same as FAU 150, except for differences in operation resulting from different configurations. Any sensor channel configuration described herein, modified to exclude the microlenses, may be substituted for the configuration of sensor channels 161, 162 that are shown in FIG. 10. A potential advantage of not including a microlens is that calibration is not needed to account for the presence of the microlens in determining the distance between the FAU and the DUT. Similar to the example of FIG. 2, two sensor channels 161, 162 can be close ton or shorter than, the testing channels 155 due to specific DUT structures. For example, in FIG. 10 the DUT has V-shaped grooves. The testing channels may be shifted down into the grooves for testing. So, sensor channels 161, 162 are slightly shorter than channels 155 to avoid hitting the DUT surface at the two opposite ends of V-shaped grooves.

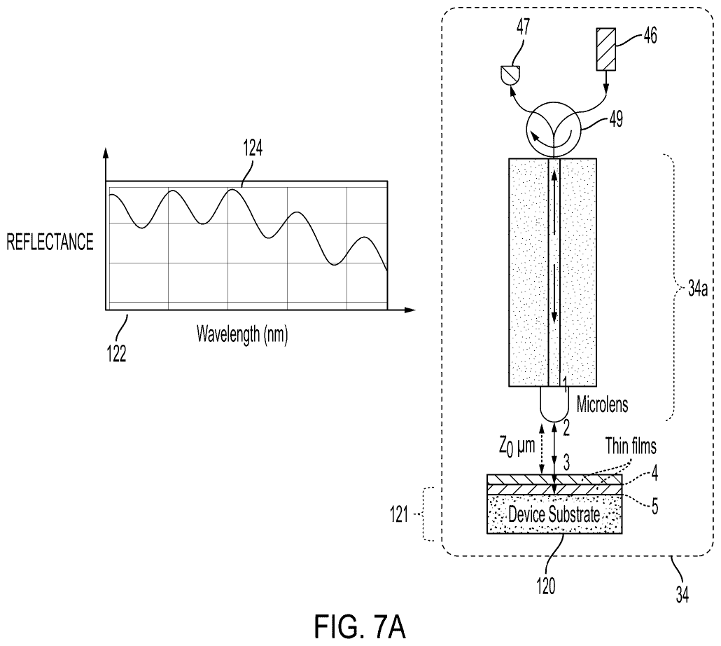

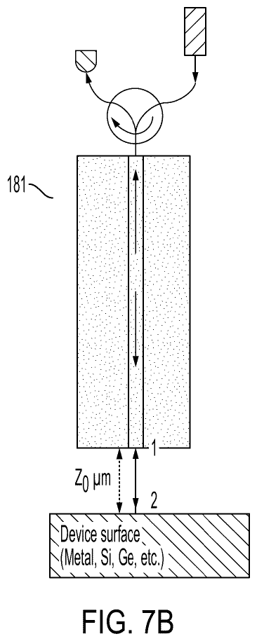

For sensor channels without microlenses as shown in FIG. 10, light reflections from the flat surfaces of the air gap between the optical waveguide/fiber and the DUT can form an interference spectrum with a simple periodic pattern and fly height Z measurements can be derived from this spectrum and optical principle as described below. Referring to FIG. 7B, the free spectral range Δλ is the spacing in wavelength between two successive reflected optical intensity maxima or minima—the formula Δλ=λ²/2Z for an interferogram is derived from the principles of wave interference and the properties of optical cavities. The reflected light power will vary for different fly heights due to the fiber or lens numerical aperture (NA).

For coarse distance measurements, e.g., having an accuracy of single-digit microns, the average free spectral range can be obtained using the formula Δλ=λ²/2Z. Analytical modeling and spectral fitting can be used as well, but it may be challenging, in some cases, to cover a wide distance range, e.g., 50 μm-2 mm. If Z>200 μm, a narrower wavelength range or lower wavelength sampling points can be used.

For fine distance measurements, e.g., having an accuracy of less than 0.1 μm, by correlating a small spectral difference to fine fly height change, e.g., 0.1 μm, the fly height can be determined by using methods such as analytical modeling and spectral fitting, or other methods such as machine learning, with an accuracy on the order of single-digit nanometers. The fine fly height may be determined using multiple datapoints, such as the maximum/minimum values, to determine the averaged spectral period for fly height calculations: Δλ=λ²/2Z.

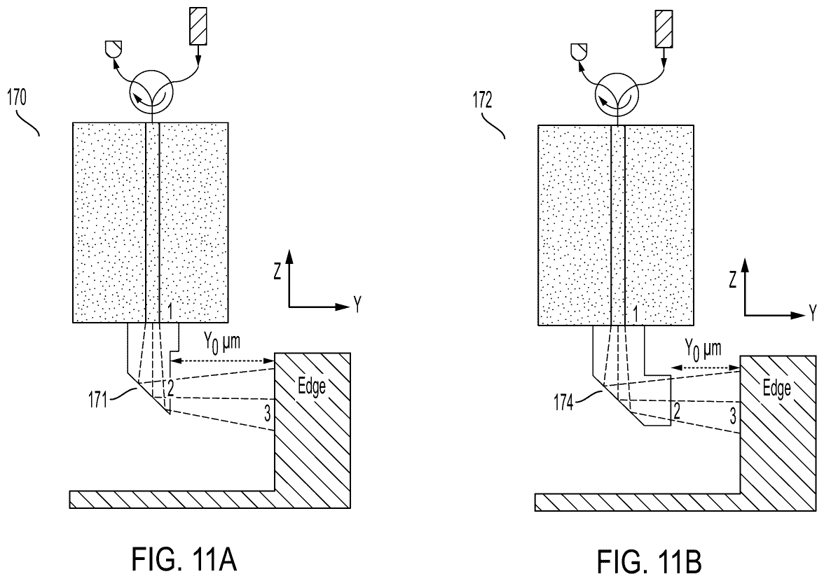

FIG. 11A and FIG. 11B are close-up and cross-sectional front views of additional examples implementation of FAU 12. In these examples, only sensor channel 170 or 172 of the FAU is shown. The remainder of the FAU, which is not shown in FIG. 11, may include test channels and another sensor channel like those shown and described herein. For example, sensor channel 172 may be incorporated into an FAU like those of FIG. 2, 3, 5, 6, 8, 9, or 10.

In the example of FIG. 11A, only sensor channel 170 of the FAU is shown. The remainder of the FAU, which is not shown in FIG. 11A, may include test channels and another sensor channel like those shown and described herein. For example, sensor channel 170 may be incorporated into an FAU like those of FIG. 2, 3, 5, 6, 8, 9, or 10.

The difference between the implementation of FIG. 11A and the implementation of FIG. 4 is in optical waveguide and total reflector units 171 and 174 at the end of the optical cable or waveguide. Optical units 171 and 174 include relatively smooth and flat surface 2. Light reflections from relatively smooth and flat surfaces 2 and 3 can form a relatively strong interference spectral pattern, which can be used to determine the air gap distance Y₀ between surface 2 and DUT edge surface 3. Unlike in FIG. 4, which focuses light onto the edge, optical unit 171 and 174 allow the light to disperse onto the edge and to reflect back into the optical waveguide and eventually reach the detector. Measurements are then obtained based on the reflected light as described herein. This Y₀ distance may be used for edge coupling-once it is accurately measured by this optical sensor without any reference, the working distance of other test channels in FAU 12 is certain; accordingly tests can be conducted and the working distance can be monitored for crash preventions or other purposes. The example of FIG. 11B includes additional optics to achieve the results described with respect to FIG. 11A.

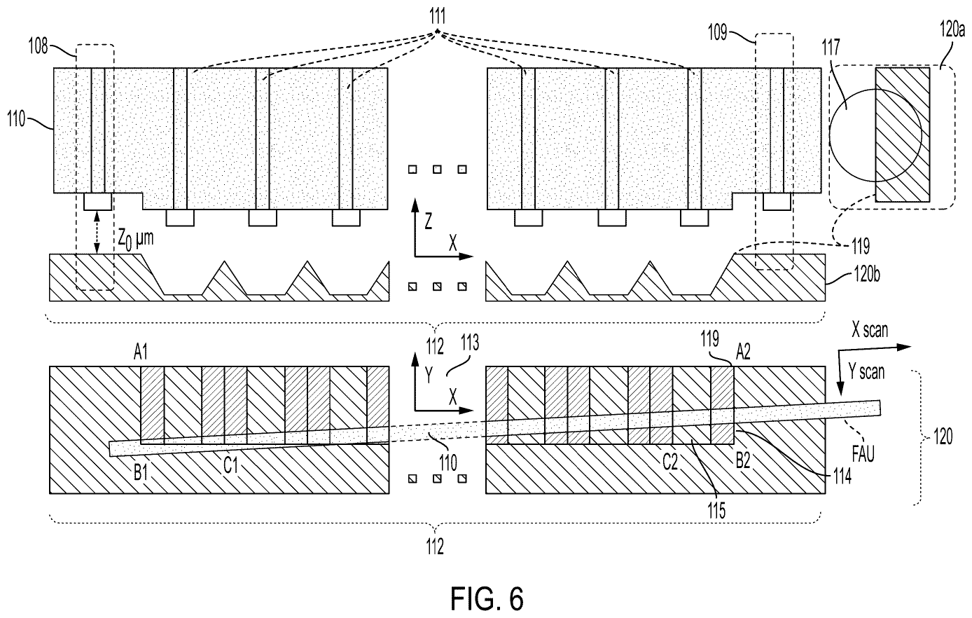

The systems described herein, and variants thereof described herein, may be used to detect edges on a DUT, such as edges of grooves or trenches on the DUT, and to align the FAU and the DUT. For example, referring to FIG. 6, to implement at least some of this functionality, the control system may control the coarse and/or fine positioners to move the FAU relative to the DUT in one, two, or three dimensions. For example, the control system may control the piezoelectric positioner to move the FAU relative to the DUT and thereby scan laser light from the FAU onto the DUT. Movement may be at sub-micron resolutions to enable edge detection (described below) of 3D micro-structures or micro-patterns of the DUT due to their different reflections from the surface of the DUT. The photodetector receives light reflections from multiple, e.g., two, sensor channels. This information may be used to assist with alignment between the FAU and the DUT, as described below. In some implementations, the shorter the wavelength of the light that is output to from the FAU to the DUT, e.g., from a laser source, the smaller the laser beam size need be. As a result, edges may be detected at a better resolution than with larger diameter laser beam outputs.

FIG. 6 shows an FAU 110, which includes sensor channels 108, 109 having any one or more of the configurations described herein along with multiple test channels 111 also having any one or more of the configurations described herein. As described below, in a case where a DUT 112 has V-shaped grooves, the control system controls FAU 111 to scan the DUT in the X and Y dimensions using the sensor channels to detect A1-B1 (or A2-B2) and B1-C1 (or B2-C2) edges, examples of which are labeled 114 and 115 respectively. This is shown in the top-down view 120 of DUT 112 of FIG. 6 (DUT 112 otherwise show in front view 120b in FIG. 6). Detection may be performed with high accuracy, e.g., down to the submicron level, to enable X and Y dimension registration and angular alignment of the FAU. This can apply to other-shaped grooves or trenches.

Edge detection resolution may be dependent on the size (e.g., the diameter) of a cross-section of the laser light beam incident on the DUT and the signal-to-noise ratio (SNR) of the detected light reflection. Smaller beam size may be more sensitive to X and Y dimension 113 scanning than larger beam sizes having the same optical power, meaning that smaller beam sizes may produce better reflections resulting in a better edge detection, as indicated above. A calculation to implement edge detection is provided in the following example. As shown in FIG. 6, if an incident laser light beam 117 having a cross-sectional spot diameter of 10 μm lands at its center on the edge of a V-shaped groove or trench 119 (edge 119 is enlarged and shown top-down in view 120a), approximately half of beam power is reflected back to the photodetector (not shown in FIG. 6). In this example, when the beam is moved 0.1 μm, the reflection light power difference is about 2.5%. A sensor system having SNR of 100 can detect this 2.5% power change, corresponding to an approximate 0.1 μm resolution, which may be satisfactory for some microchip alignment requirements.

The control system may store, in memory 25, all X, Y, Z locations of the FAU relative to the DUT, where the Z locations are determined by the sensor channels using the techniques described herein. Using this information, the control system may control the piezoelectric positioner and/or the hexapods to move the FUA relatively quickly to couple laser light from the FAU into DUT waveguides for further tests or measurements. In some implementations, the alignment and edge detection processes may be completed within single-digit seconds, e.g., within one second.

In addition to detecting three-dimensional (3D) structures on a DUT, such as edges, this sensor system described herein may be used to identify two-dimensional (2D) structures on a target device based on a pattern contrast.

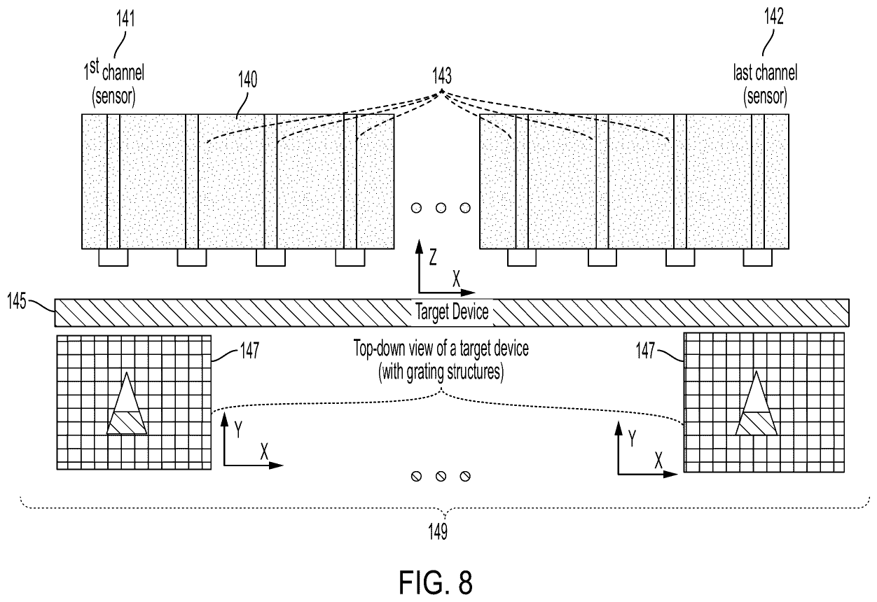

FIG. 8 shows an example FAU 140, which includes sensor channels 141, 142 and test channels 143 positioned relative to a target device 145. FAU 140 may have any of the configurations described herein or variants thereof. In this example, the target device 145 includes optical grating structures 147 for vertical coupling of light into waveguide devices on the device. These optical grating structures are shown in a top-down view 149 of the device 145 (which is otherwise show in front view in FIG. 8). The locations of the optical grating structures may be determined based on reflections of light off of the optical grating structures, e.g., different optical signal strength, which correspond to different features of the grating structures, may produce different amounts of reflections.

Referring to FIG. 7A, an example DUT 120 includes one or more thin film or dielectric layers in target devices. The thickness(es) of these thin film layers may be determined as part of a process to locate the center of the target (e.g., a waveguide) on the DUT. The sensor channels shown in the figures and corresponding assemblies described herein may be used to measure the dielectric or other thin film (e.g., metal) layer thickness. Such measurements may be performed using a laser or other light source that is broadband or that is controllable by the control system to sweep across multiple wavelengths, e.g., to produce multiple wavelengths of light in succession. As shown in FIG. 7A (which depicts sensor channel 34a of FIG. 2 used as an example), the spectrum 122 of the reflected laser light has an interference pattern 124 that is based on the thickness and materials of layers 121 on a target device—reflections from surfaces 1, 2, 3, 4, 5 form this characteristic spectrum (surfaces 2 reflection is relatively small). If the control system knows the refractive index and extinction coefficient of the dielectric materials, the control system can determine the reflected spectrum based on the signals it receives from the photodetectors use the reflection spectrum to determine the fly height and the thickness of each dielectric layer based on theoretical calculations, analytical modeling, or machine learning based approach, with an accuracy on the order of nanometers or Angstroms.

For dielectric layers, in some implementations, the measurement range can potentially be from a few nanometers up to 100 microns or more, with nanometer (nm) or better accuracy. For metal layers, the thickness measurement range may be smaller (due to metals' high extinction coefficients), ranging, e.g., from be 1 nm to 100 nm.

FIG. 7B shows an example DUT having a smooth metal or semiconductor surface with a sensor channel 181 like sensor channel 161 of FIG. 10. In this example, reflections from flat surfaces 1 and 2 form an interference spectrum having a simple periodic pattern as described previously, which may make distance determinations easier than in the example of FIG. 7A.

The sensor channels described herein or variants thereof and corresponding assemblies to implement those sensor channels or variants thereof may be used to implement crash prevention or to reduce the possibility of unintended contact, during testing, between the FAU or components thereof and the DUT. Crash prevention may be of relevance during high-volume automation microchip manufacturing. Using the information obtained from the photodetectors via the sensor channels associated with or integrated within the FAU, the control system can continuously monitor the location and orientation (e.g., the X, Y, Z coordinates) of the FAU relative to the DUT. For example, the control system may compare the location and/or orientation of the FAU relative to the DUT to one or more predefined thresholds. The control system can provide a crash alert, which may be an audio or visual indicator, when the FAU reaches a threshold distance from the target device. The control system may control the piezoelectric positioner and/or the hexapods to move the FAU away from the DUT or to stop movement altogether in the event that location and/or orientation of the FAU relative to the DUT is below a predefined threshold (e.g., too close to the DUT).

The example sensor channel assemblies described herein are described as being at ends—e.g., opposite ends—of the FAU. However, instances of each assembly may be at any appropriate location along the same FAU, or other separate FAUs while the sensing signals can be used by the control system. In addition, different combinations of assemblies may be used in a single FAU. For example, one location of an FAU may include assembly 34a and a second, different location of the FAU may include an assembly 54a, 65a, 93, 152, or 161. For example, one location of an FAU may include assembly 54a and a second, different location of the FAU may include an assembly 44a, 65a, 93, 152, or 161. For example, one location of an FAU may include assembly 65a and a second, different location of the FAU may include an assembly 34a, 54a, 93, 152, or 161. For example, one location of an FAU may include assembly 93 and a second, different location of the FAU may include an assembly 34a, 54a, 65a, 152, or 161. In some implementations, a single FAU may include three or more assemblies of the type described herein, e.g., three, four, five, six, and so forth assemblies to perform sensing.

The sensor system with any combinations of one or multiple fiber sensor channels from the configurations described herein can be used for various types of sensing applications. For example, such a sensor system can be used with one or more fiber sensor channels in the context of microchip processes, such as wafer inspection, laser welding/soldering, and epoxy bonding.

All or part of the systems and processes described herein including but not limited to the FAUs and test systems described herein and variants thereof may be configured and/or controlled at least in part by one or more processing devices using one or more computer programs tangibly embodied in one or more information carriers, such as in one or more non-transitory machine-readable storage media. A computer program can be written in any form of programming language, including compiled or interpreted languages, and it can be deployed in any form, including as a stand-alone program or as a module, part, subroutine, or other unit suitable for use in a computing environment. A computer program can be deployed to be executed on one computer or on multiple computers at one site or distributed across multiple sites and interconnected.

Actions associated with configuring or controlling the test system and processes described herein can be performed by one or more programmable processors executing one or more computer programs to control or to perform all or some of the operations described herein. All or part of the test systems and processes can be configured or controlled by special purpose logic circuitry, such as, an FPGA (field programmable gate array) and/or an ASIC (application-specific integrated circuit) or embedded microprocessor(s) localized to the instrument hardware.

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, such as magnetic, magneto-optical disks, or optical disks. Non-transitory machine-readable storage media suitable for embodying computer program instructions and data include all forms of non-volatile storage area, including by way of example, semiconductor storage area devices, such as EPROM (erasable programmable read-only memory), EEPROM (electrically erasable programmable read-only memory), and flash storage area devices; magnetic disks, such as internal hard disks or removable disks; magneto-optical disks; and CD-ROM (compact disc read-only memory) and DVD-ROM (digital versatile disc read-only memory).

As used herein, the terms “comprises,” “comprising,” “includes,” “including,” “has,” “having,” “contains,” “containing,” and any variations thereof, are intended to cover a non-exclusive inclusion, such that systems, techniques, apparatus, structures, processes, or other subject matter described or claimed herein that includes, has, or contains an element or list of elements does not include only those elements but can include other elements not expressly listed or inherent to such systems, techniques, apparatus, structures, processes or other subject matter described or claimed herein.

All examples described herein are non-limiting.

In the description and claims provided herein, the adjectives “first”, “second”, “third”, and the like do not designate priority or order unless context suggests otherwise. Instead, these adjectives may be used solely to differentiate the nouns that they modify.

Any mechanical, optical, or electrical coupling or connection herein may include a direct physical connection or an indirect physical connection that includes one or more intervening devices unless context suggests otherwise. A connection or coupling between two optical devices may include one or more intervening devices to implement the connection or coupling.

Elements of different implementations described may be combined to form other implementations not specifically set forth previously. Elements may be left out of the systems described previously without adversely affecting their operation or the operation of the system in general. Furthermore, various separate elements may be combined into one or more individual elements to perform the functions described in this specification.

Other implementations not specifically described in this specification are also within the scope of the following claims.

What is claimed is:

1. A test system comprising:
a light source configured to output light;
a photodetector to receive a reflection of the light;
an optical cable that is optically coupled to the light source and the photodetector; and
wherein an end of the optical cable or a microlens proximate to the end of the optical cable is configured to output the light from the light source to a target device to produce the reflection of the light.

2. The test system of claim 1, further comprising:
one or more processing devices to determine a distance to the target device based on the reflection received at the photodetector.

3. The test system of claim 2, wherein at least the optical cable and the microlens are part of a test unit; and
wherein the one or more processing devices are configured to control movement of the test unit.

4. The test system of claim 3, wherein the one or more processing devices are configured to control movement of the test unit so as to prevent contact between at least part of the test unit and the target device.

5. The test system of claim 2, wherein the one or more processing devices are configured to determine, based on the reflection received at the photodetector, a thickness of one or more film layers on the target device.

6. The test system of claim 1, wherein the light source is a first light source, the light is first light, the photodetector is a first photodetector, the optical cable is a first optical cable, the microlens is a first microlens, and the reflection is a first reflection; and
wherein the test system further comprises:
a second light source configured to output second light;
a second photodetector to receive a second reflection of the second light;
a second optical cable that is optically coupled to the second light source and the second photodetector; and
a second end of the optical cable or a second microlens at the second end of the second optical cable to output the second light from the second light source to the target device to produce the second reflection.

7. The test system of claim 6, wherein the first microlens is configured to output the first light to a first location on the target device and the second microlens is configured to output the second light to a second location on the target device, the first location being different from the second location.

8. The test system of claim 7, further comprising:
multiple optical test channels between the first optical cable and the second optical cable, the optical test channels comprising respective optical cables having respective microlenses at ends thereof or not to perform optical testing at a surface of the target device, the surface being either orthogonal to the optical test channels or at a non-zero angle relative to the optical test channels.

9. The test system of claim 1, further comprising:
one or more processing devices to determine an alignment of the first microlens and the second microlens to the target device based on the first reflection and the second reflection.

10. The test system of claim 1, wherein the microlens has a diameter of 5 microns to 200 microns.

11. The test system of claim 1, wherein the microlens is a first microlens and the reflection is a first reflection;
wherein the optical cable comprises an optical splitter to create a first optical line and a second optical line;
wherein the first microlens is at an end of the first optical line and wherein a second optical lens is at an end of the second optical line; and
wherein the first microlens is configured to output a first part of the light to the target device and to receive the first reflection and the second microlens is configured to output a second part of the light to the target device and to receive a second reflection of the second part of the light from the target device.

12. The test system of claim 11, further comprising:
multiple optical test channels, the optical test channels comprising respective optical cables having respective microlenses at ends thereof or not to perform testing at a surface of the target device, the surface being either orthogonal to the optical test channels or at a non-zero angle relative to the optical test channels.

13. The test system of claim 11, wherein the first microlens and the second microlens are configured to output, respectively, the first part of the light and the second part of the light are output to a same location on the target device.

14. The test system of claim 1, wherein the microlens is a first microlens;
wherein the test system comprises a second microlens at the end of the optical cable; and
wherein the first microlens is configured to direct a first part of the light to a first part of the target device and the second microlens is configured to direct a second part of the light to a second part of the target device, the first part of the target device being different than the second part of the target device.

15. The test system of claim 14, wherein the first part of the target device is non-parallel to the second part of the target device.

16. The test system of claim 14, wherein the first microlens is designed not to have total internal reflection and the second microlens is designed to have total internal reflection.

17. The test system of claim 1, wherein at least the optical cable and the microlens are part of a test unit; and
wherein the test system further comprises:
a fine positioning device configured to move the test unit relative to the target device in three dimensions; and
a coarse positioning device configured to move the test unit and the fine positioning device relative to the target device in six degrees of freedom, the coarse positioning device being configured to move over a range that is at least an order of magnitude greater than a range over which the fine positioning device is configured to move the test unit.

18. The test system of claim 17, wherein the coarse positioning device comprises one or more hexapods.

19. The test system of claim 17, wherein the fine positioning device comprises a piezoelectric positioner.

20. The test system of claim 1, The test system of claim 11, further comprising:
a substrate holding the optical cable;
wherein the substrate holds additional optical cables having respective microlenses at ends thereof or not to perform testing at a surface of the target device; and
wherein the substrate has a different dimension at the optical cable than at the additional optical cables.

21. The test system of claim 20, wherein the substrate is shorter at the optical cable than at the additional optical cables.

22. The test system of claim 1, The test system of claim 11, further comprising:
a substrate holding the optical cable;
wherein the substrate holds additional optical cables having respective microlenses at ends thereof or not to perform testing at a surface of the target device; and
wherein the substrate has a same dimension at the optical cable than at the additional optical cables.

23. A test system comprising:
a light source configured to output light;
a first optical cable that is optically coupled to the light source;
wherein a first end of the first optical cable or a first microlens proximate to the first end of the first optical cable is configured to output the light from the light source to target device;
a photodetector;
a second optical cable that is optically coupled to the photodetector; and
wherein a first end of the second optical cable or a second microlens proximate to the second end of the second optical cable is configured to receive a reflection of the light from the target device.

24. The test system of claim 23, wherein the first optical cable and the second optical cable are part of a test unit; and
wherein the test system further comprises:
a fine positioning device configured to move the test unit relative to the target device in three dimensions; and
a coarse positioning device configured to move the test unit and the fine positioning device relative to the target device in six degrees of freedom, the coarse positioning device being configured to move over a range that is at least an order of magnitude greater than a range over which the fine positioning device is configured to move the test unit.

25. The test system of claim 23, further comprising:
one or more processing devices to determine a distance to the target device based on the reflection received at the photodetector.

26. The test system of claim 25, wherein the first optical cable and the second optical cable are part of a test unit; and
wherein the one or more processing devices are configured to control movement of the test unit.

27. The test system of claim 25, wherein the one or more processing devices are configured to control movement of the test unit so as to prevent contact between at least part of the test unit and the target device.

28. The test system of claim 25, wherein the one or more processing devices are configured to determine, based on the reflection received at the photodetector, a thickness of one or more film layers on the target device.

29. A method for use with a test unit comprising at least first and second instances of an assembly comprising one or more optical cables, and one or more microlenses at one or more respective ends of the one or more optical cables; the method comprising:
moving the test unit in a first dimension relative to a target device while a first assembly outputs first light to the target device and receives a first reflection of the first light and while a second assembly outputs second light to the target device and receives a second reflection of the second light;
moving the test unit in a second dimension relative to the target device while the first assembly outputs third light to the target device and receives a third reflection of the third light and while the second assembly outputs fourth light to the target device and receives a fourth reflection of the fourth light, the second dimension being different than the first dimension; and
registering the test unit relative to the target device based on the first reflection, the second reflection, the third reflection, and the fourth reflection.

30. The method of claim 29, wherein the first dimension is orthogonal to the second dimension.

31. The method of claim 29, wherein the target device comprises grooves;
wherein moving the test unit in the first dimension scans the first light across a first groove and scans the second light across a second groove; and
wherein moving the test unit in the second dimension scans the third light across the first groove and scans the fourth light across the second groove.

32. The method of claim 29, wherein the test unit comprises multiple optical test channels between the first assembly and the second assembly; and
wherein the method further comprises, following registering, testing operation of the target device using the multiple optical test channels.
